(19) United States
(12) Patent Application Publication
(10) Pub. No.: US 2026/0286659 A1
(43) Pub. Date: Sep. 24, 2026

(54) Method Of Determining An Estimated Payload Weight Of A Work Machine And Device Configured To Determine An Estimated Payload Weight Value Of A Work Machine

(71) Applicant: Caterpillar Inc., Peoria, IL (US)

(72) Inventors: Eric W. Cler, Oswego, IL (US); Corey Lee Gorman, Peoria, IL (US); Aaron Shatters, Montgomery, IL (US)

(21) Appl. No.: 19/472,418

(22) PCT Filed: Mar. 8, 2024
(86) PCT No.: PCT/US2024/019103

§ 371 Date: Oct. 3, 2025

(30) Foreign Application Priority Data
Apr. 25, 2023 (GB) 2306050.2

(51) Int. Cl. E02F 9/26; E02F 3/32; E02F 9/20; G01G 19/12

(52) U.S. Cl. CPC E02F 9/264; G01G 19/12; E02F 3/32; E02F 9/2095

(57) ABSTRACT

A method of determining an estimated payload weight of a work machine is provided, wherein the work machine comprises a boom and a boom lift electronic actuator configured to actuate the boom. The method comprises determining a preliminary estimated weight value of the payload using a net force on the boom lift electronic actuator and a position of the boom. The net force on the boom lift actuator is determined from a motor current of the boom lift electronic actuator, wherein the motor current is indicative of a motor torque and wherein the motor torque is indicative of a net force on the actuator. The method further comprises adjusting the preliminary estimated weight value to provide an estimated payload weight value, wherein the adjustment comprises filtering. The method further comprises outputting the estimated payload weight value.

### FIELD OF DISCLOSURE

The disclosure relates to the field of work machines.

### BACKGROUND

It is known to provide actuators on work machines or work tools configured to lift or carry a payload. The actuators move and control components of the work machine to allow the work machine to lift, manoeuvre and carry a payload. For example, the work machine may comprise an arm. A wheel loader may comprise a boom and a coupler connected to a work tool such as a bucket, while an excavator may comprise a boom, stick and coupler. A work machine may comprise one or more actuators or cylinders configured to move and control one or more of a boom, stick and bucket.

Conventionally, such actuators are hydraulic actuators or cylinders. The mass of the payload in a work tool may be measured or estimated based on a hydraulic pressure of the lift hydraulic cylinder or boom hydraulic cylinder.

Increasingly, electrification of work vehicles and work machines is being considered. Replacing the hydraulic cylinders with electric or electromechanical actuators allows precise velocity and acceleration control, as well as allowing the force on an individual actuator to be managed. The speed and position of an electromechanical actuator can also be sensed. However, the simple measurement of payload for hydraulic cylinders is facilitated by the direct correlation between cylinder pressure and payload. Replacing the hydraulic cylinders with electric actuators means losing the ability to measure the payload using the cylinder pressure. It is an object of this disclosure to provide a method for measuring the payload for work machines having electric actuators.

### SUMMARY OF THE DISCLOSURE

Against this background, there is provided a method of determining an estimated payload weight of a work machine, wherein the work machine comprises a boom and a boom lift electronic actuator configured to actuate the boom. The method comprises determining a preliminary estimated weight value of the payload using: a net force the boom lift electronic actuator determined from a motor current of the boom lift electronic actuator, wherein the motor current is indicative of a motor torque and wherein the motor torque is indicative of a net force on the actuator; and a position of the boom. The method further comprises adjusting the preliminary estimated weight value to provide an estimated payload weight value, wherein the adjustment comprises filtering. The method further comprises outputting the estimated payload weight value.

In this way, it is possible to estimate a weight of a payload in a work tool for a work machine having an electronic actuator. The motor current of the electronic actuator may be used in the estimation.

There is also provided a device configured to determine an estimated payload weight value of a work machine, wherein the work machine comprises a boom and a boom lift electronic actuator configured to actuate the boom. The device is configured to determine a preliminary estimated weight value of the payload using: a net force on the boom lift electronic actuator determined from a motor current of the boom lift electronic actuator, wherein the motor current is indicative of a motor torque and wherein the motor torque is indicative of a net force on the actuator; and a position of the boom. The device is further configured to adjust the preliminary estimated weight value to provide an estimated payload weight value, wherein the adjustment comprises filtering. The device is further configured to output the estimated payload weight value.

### BRIEF DESCRIPTION OF THE DRAWINGS

A specific embodiment of the disclosure will now be described, by way of example only, with reference to the accompanying drawings in which:

FIG. 1 shows a schematic diagram of a side view of a work machine configured to lift or carry a payload, for which a method according to an embodiment of the present disclosure may be used to determine the payload.

FIG. 2 shows a schematic diagram of a side view of a section of a work machine configured to lift or carry a payload, for which a method according to an embodiment of the present disclosure may be used to determine the payload.

FIG. 3 shows a schematic diagram of a side view of a work machine configured to lift or carry a payload, for which a method according to an embodiment of the present disclosure may be used to determine the payload.

FIG. 4 shows a flowchart illustrating a method of determining a payload of a work machine according to an embodiment of the present disclosure.

FIG. 5 shows a flowchart illustrating a method of determining a payload of a work machine according to an embodiment of the present disclosure.

FIG. 6 shows a flowchart illustrating a method of determining a payload of a work machine according to an embodiment of the present disclosure.

FIG. 7 shows a flowchart illustrating a method of determining a payload of a work machine according to an embodiment of the present disclosure.

### DETAILED DESCRIPTION

Work machines may comprise one or more actuators configured to lift or carry a payload. The one or more actuators control components of the work machine to allow the work machine to lift, manoeuvre or carry a payload. A method is provided of determining a payload of a work machine. The work machine comprises a boom and a boom lift electronic actuator configured to actuate the boom. The boom may comprise any arm or component that can be actuated to allow the work machine to lift, manoeuvre or carry a payload. For example, the boom may be connected to the chassis of a work machine and the boom electronic actuator may be configured to actuate the boom relative to the chassis. In certain embodiments, the boom may be configured to connect to a work tool, wherein the work tool is configured to hold a payload. The boom may be configured to connect directly to the work tool at the distal end of the boom. The work tool may be movable relative to the boom. The work tool may be removable from the boom. The boom may be configured to connect to the work tool via another component of the work machine, such as a stick. The work tool may be movable relative to the stick or other component. The work tool may be removable from the component. The work tool may, for example, comprise a bucket.

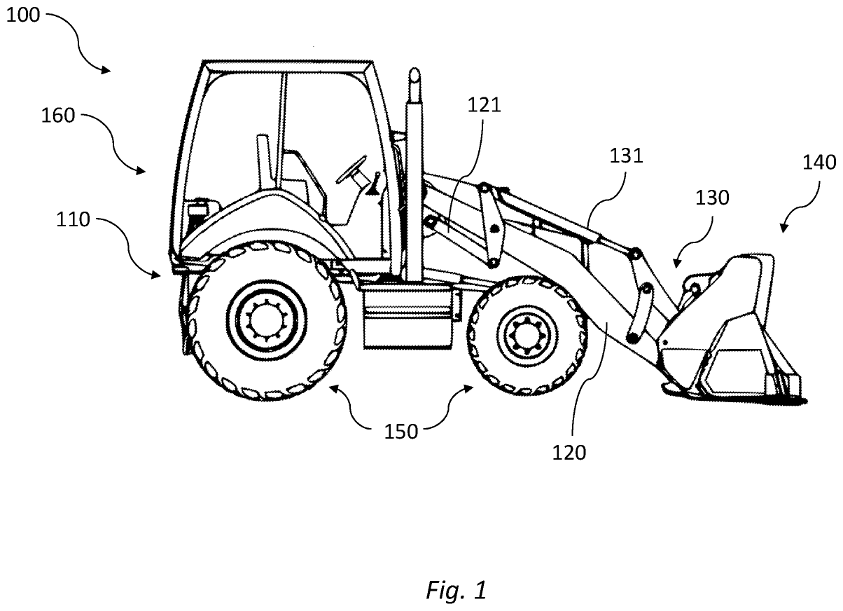

With reference to FIGS. 1 to 3, examples of a work machine comprising a boom and boom lift electronic actuator are illustrated. These are illustrative, and other configurations of boom and boom lift electronic actuator are possible. For example, the work machine may comprise a Z-bar linkage.

FIG. 1 shows a wheel loader 100. The wheel loader comprises a chassis 110. The wheel loader 100 further comprises a boom 120 connected to the chassis 110, wherein the boom 120 is movable relative to the chassis 110. The boom 120 is configured to be actuated by a boom lift electronic actuator 121. The wheel loader 100 further comprises a coupler 130 for connection to a work tool 140, wherein the work tool 140 comprises a bucket. The coupler 130 is configured to be actuated by a tilt electronic actuator 131. The wheel loader 100 further comprises wheels 150 and a cab 160, wherein the cab 160 is connected to the chassis 110.

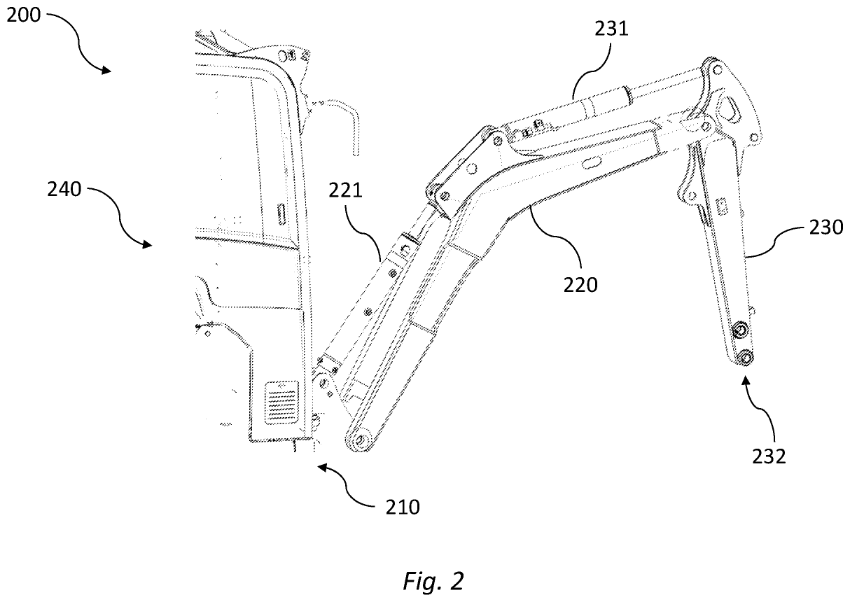

FIG. 2 shows a section of an excavator 200 comprising a chassis 210. The excavator 200 comprises a boom 220 connected to the chassis 210, wherein the boom 220 is movable relative to the chassis 210. The boom 220 is configured to be actuated by boom lift electronic actuator 221. The excavator further comprises a stick 230 connected to the distal end of the boom 220, wherein the stick 230 is movable with respect to the boom 220. The stick 230 is configured to be actuated by a stick electronic actuator 231, such that the stick 230 rotates about a point of connection between the boom 220 and the stick 230. The stick 230 may be configured to attach to a work tool via a coupler at the distal end 232 of the stick 230. The coupler may be configured to be actuated by a tilt electronic actuator. The excavator 200 further comprises a cab 240.

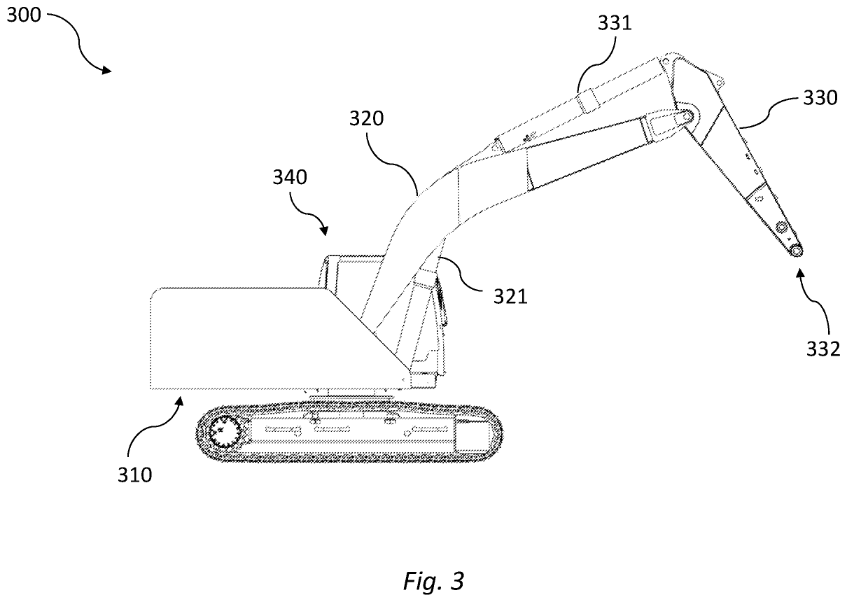

FIG. 3 shows an excavator 300 comprising a chassis 310. Similarly to the excavator 200 shown in FIG. 2, the excavator 300 comprises a boom 320 connected to the chassis 310, wherein the boom 320 is movable relative to the chassis 310. The boom 320 is configured to be actuated by boom lift electronic actuator 321. For excavator 200, the boom lift electronic actuator 221 actuates the boom 220 from above the boom 220. For excavator 300, the boom lift electronic actuator 321 actuates the boom 320 from below the boom 320. The excavator further comprises a stick 330 connected to the distal end of the boom 320, wherein the stick 330 is movable with respect to the boom 320. The stick 330 is configured to be actuated by a stick electronic actuator 331, such that the stick 330 rotates about a point of connection between the boom 320 and the stick 330. The stick 330 may be configured to attach to a work tool via a coupler at the distal end 332 of the stick 330. The coupler may be configured to be actuated by a tilt electronic actuator. The excavator 300 further comprises a cab 340.

The methods and device described herein may be used for any work machine comprising a boom and a boom lift electronic actuator, including but not limited to the work machines illustrated in FIGS. 1 to 3. As used herein, a linkage of a work machine may comprise any component of the work machine that is used to lift, carry or manoeuvre the payload. For example, a linkage may comprise a boom, stick, coupler or work tool.

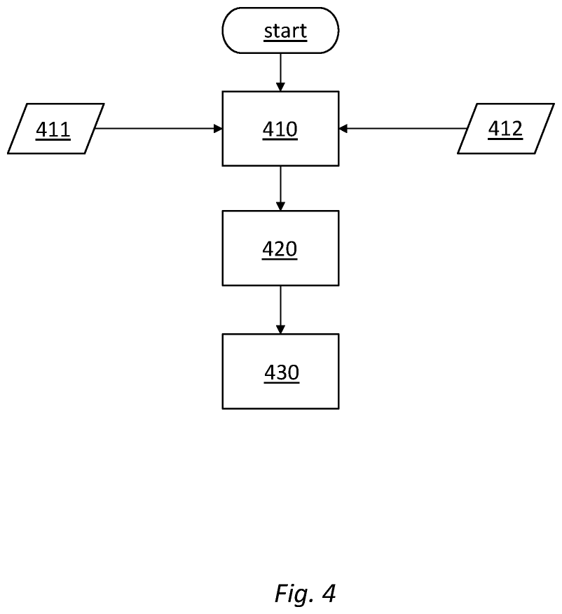

A method is provided of determining a payload of a work machine. The work machine comprises a boom and a boom lift electronic actuator configured to actuate the boom. With reference to FIG. 4, the method comprises determining a preliminary estimated weight value of the payload at step 410. Step 410 of determining a preliminary estimated weight value of the payload uses a net force on the boom lift electronic actuator 411 and a position of the boom 412. The net force on the boom lift electronic actuator 411 is determined from a motor current of the boom lift electronic actuator, wherein the motor current is indicative of a motor torque and wherein the motor torque is indicative of a force on the actuator. The motor torque may be indicative of a force on the actuator when a brake or load hold attached to the actuator is released or not enabled. The torque may be used with the position of the boom 412 to provide the net force on the boom actuator. The position of the boom 412 may comprise an angle and a length of the boom. The method further comprises adjusting the preliminary estimated weight value at step 420 to provide an estimated payload weight value, wherein the adjustment comprises filtering. At step 430, the method comprises outputting the estimated payload weight value.

Filtering an estimated weight value may comprise removing one or more of noise, machine resonance and motor vibration. The filtering may comprise low pass and band pass filters. The filtering may comprise a time average of the weight value.

The method may further comprise compensating for acceleration by using a filtered angular acceleration. The step of compensating for acceleration may occur after the filtering step 420. Step 420 may comprise filtering the preliminary estimated weight value to provide a filtered estimated weight value, and the method may further comprise adjusting the filtered estimated weight value to compensate for acceleration by using a filtered angular acceleration to provide an estimated payload weight value. The step of compensating for acceleration may occur prior to the filtering step, such that the preliminary estimated weight value is adjusted to compensate for acceleration and the compensated weight is used in the filtering step 420.

Compensating an estimated weight value for acceleration may comprise estimating angular acceleration using a weigh range. The weigh range may comprise a start lift position of the boom and an end lift position of the boom. The weigh range may be configurable. In certain embodiments, a user of the work machine may provide the weigh range. A difference between an angular velocity of the boom entering the weigh range and an angular velocity of the boom exiting the weight range may be determined. A time taken to through the weigh range may also be determined. The estimate of angular acceleration may then be determined by dividing the difference in angular velocity by the time taken. Using the estimate of angular acceleration, a moment of inertia of the linkage and an estimated weight value, it is possible to estimate how much additional force is being induced and measured due to acceleration compared to the force induced and measured due to the actual payload. The acceleration force may be subtracted from the measured force to derive a compensated estimate of the force associated with the actual payload.

In certain embodiments, step 410 of determining the preliminary estimated weight value may comprise using a weight lookup table or weight lookup map. The weight lookup table or map weight lookup table or map may comprise friction compensation based on a velocity of the boom lift electronic actuator, wherein determining the preliminary estimated weight value further uses a velocity of the boom lift electronic actuator. The friction compensation may be determined during a calibration by raising the boom and lowering the boom at more than one speed, with the same payload. This may be repeated for more than one payload.

In certain embodiments, the work machine may further comprise a tilt actuator. For example, the work machine may comprise a coupler configured to connect to a work tool, wherein the tilt actuator is configured to actuate the coupler. The method may further comprise a step of compensating for the tilt angle using a position of the tilt actuator. In certain embodiments, known kinematics of linkages of the work machine and an assumed centre of gravity of the payload can be used to determine a portion of the payload that is supported by the tilt actuator, without directly determining any forces on the tilt actuator. In other embodiments, a net force on a tilt electronic actuator may be determined from a motor current of the tilt electronic actuator.

In certain embodiments, the method further comprises using the tilt electronic actuator position to adjust the preliminary estimated weight value to compensate for tilt angle. In certain embodiments, the step of determining a preliminary estimated weight value of the payload may comprises determining a supporting torque around a pin based on:
a net force on the boom lift electronic actuator; a net force on the tilt cylinder; a position of the boom; and a position of the tilt electronic actuator. The net force on the boom lift electronic actuator is determined from a motor current of the boom lift electronic actuator, wherein the motor current is indicative of a motor torque and wherein the motor torque is indicative of a force on the actuator. The net force on the tilt cylinder is determined from a motor current of the tilt electronic actuator, wherein the motor current is indicative of a motor torque and wherein the motor torque is indicative of a force on the actuator. The preliminary estimated weight value may be determined based on the supporting torque and the position of the boom. Determining the preliminary estimated weight value based on the supporting torque and the position of the boom may further comprise using a machine pitch and the position of the tilt electronic actuator. The preliminary estimated weight value may be determined based on the supporting torque, the position of the boom, the machine pitch and the position of the tilt electronic actuator using a nominal linkage model. In certain embodiments, the nominal linkage model may comprise a system of equations based on the free body diagram of the linkage components. The pin may connect the boom to the chassis, such that the boom is rotatable around the pin.

In certain embodiments, the method may further comprise calibrating the preliminary estimated weight value using a calibration scale and offset factors.

In certain embodiments, the tilt actuator may comprise a tilt electronic actuator. In certain embodiments, the tilt actuator may comprise another actuator such as a hydraulic actuator.

In certain embodiments, the centre of gravity of the payload is assumed to be similar to the centre of gravity used for a calibrated payload.

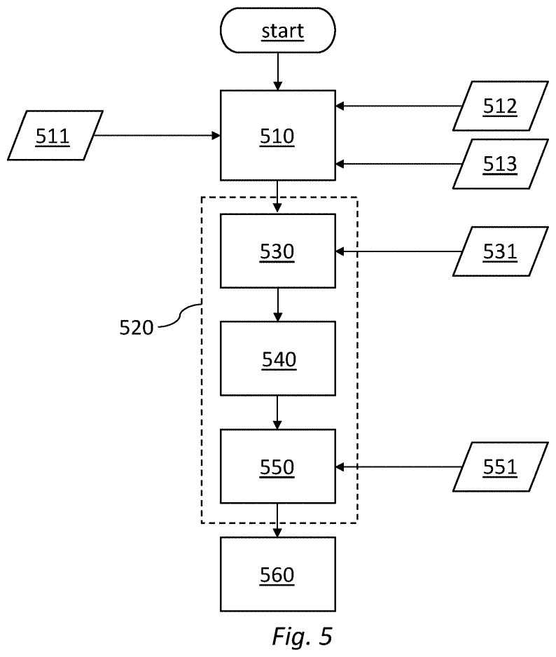

With reference to FIG. 5, a method of determining a payload of a work machine according to an embodiment of the present disclosure is illustrated. The work machine comprises a boom, a boom lift electronic actuator configured to actuate the boom and a tilt actuator configured to actuate a coupler, wherein the coupler is configured to connect to a work tool. The tilt actuator may not comprise an electronic actuator. The centre of gravity of the payload may be assumed to be similar to the centre of gravity used for a calibrated payload. The method comprises determining a preliminary estimated weight value of the payload at step 510. Step 510 of determining a preliminary estimated weight value of the payload uses a net force on the boom lift electronic actuator 511, a position of the boom 512 and a velocity of the boom lift electronic actuator 513. The preliminary estimated weight value is determined using a weight lookup map or table with the net force on the boom lift electronic actuator 511 and the position of the boom 512, wherein the weight lookup map or table takes into account friction compensation based on the velocity of the boom lift electronic actuator 513. The net force of the boom lift electronic actuator 511 is determined from a motor current of the boom lift electronic actuator, wherein the motor current is indicative of a motor torque and wherein the motor torque is indicative of a force on the actuator. The method further comprises adjusting the preliminary estimated weight value to provide an estimated payload weight value. The adjustment steps 520 comprise adjusting the preliminary estimated weight value at step 530 to compensate for tilt angle and provide a tilt adjusted estimated weight value, using a tilt actuator position 531. The adjustment steps 520 further comprise filtering the tilt adjusted estimated weight value at step 540 to provide a filtered estimated weight value. The adjustment steps 520 further comprise adjusting the filtered estimated weight value for acceleration at step 550, using a filtered angular acceleration 551. At step 560, the method comprises outputting the estimated payload weight value. The adjustment steps 520 may be carried out in a different order.

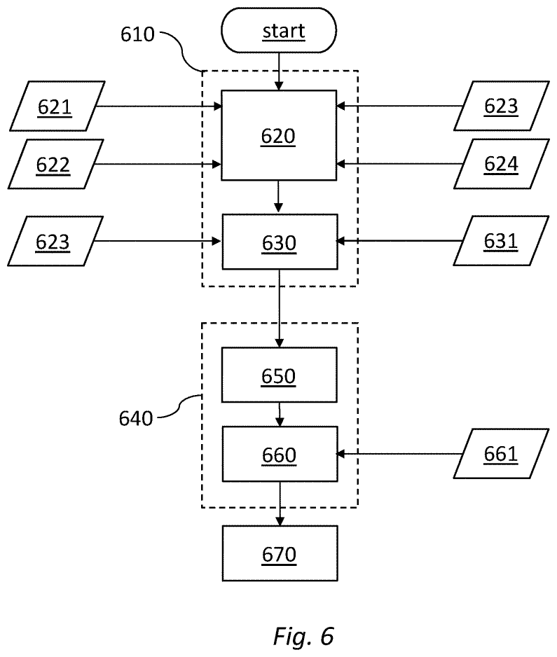

With reference to FIG. 6, a method of determining a payload of a work machine according to an embodiment of the present disclosure is illustrated. The work machine comprises a boom, a boom lift electronic actuator configured to actuate the boom and a tilt electronic actuator configured to actuate a coupler, wherein the coupler is configured to connect to a work tool. The centre of gravity of the payload may be assumed to be similar to the centre of gravity used for a calibrated payload. The method comprises determining a preliminary estimated weight value of the payload at steps 610. Step 620 comprises calculating a torque around a component configured to attach the boom to the work machine, such as a pin. Step 620 uses known kinematics and a net force on the boom lift electronic actuator 621, a net force on the tilt electronic actuator 622, a position of the boom 623 and a position of the tilt electronic actuator 624. The net force on the boom lift electronic actuator 621 is determined from a motor current of the boom lift electronic actuator, wherein the motor current is indicative of a motor torque and wherein the motor torque is indicative of a force on the actuator. The net force on the tilt electronic actuator 622 is determined from a motor current of the tilt electronic actuator, wherein the motor current is indicative of a motor torque and wherein the motor torque is indicative of a force on the actuator. At step 630, the preliminary estimated weight value is determined using the torque, the position of the boom 623, a velocity of the boom lift electronic actuator 631 and a weight lookup map or table. The weight lookup map or table takes into account friction compensation based on the velocity of the boom lift electronic actuator 631. The method further comprises adjusting the preliminary estimated weight value to provide an estimated payload weight value. The adjustment steps 640 comprise filtering the preliminary estimated weight value at step 650 to provide a filtered estimated weight value. The adjustment steps 640 further comprise adjusting the filtered estimated weight value for acceleration at step 670, using a filtered angular acceleration 661. At step 670, the method comprises outputting the estimated payload weight value. The adjustment steps 640 may be carried out in a different order.

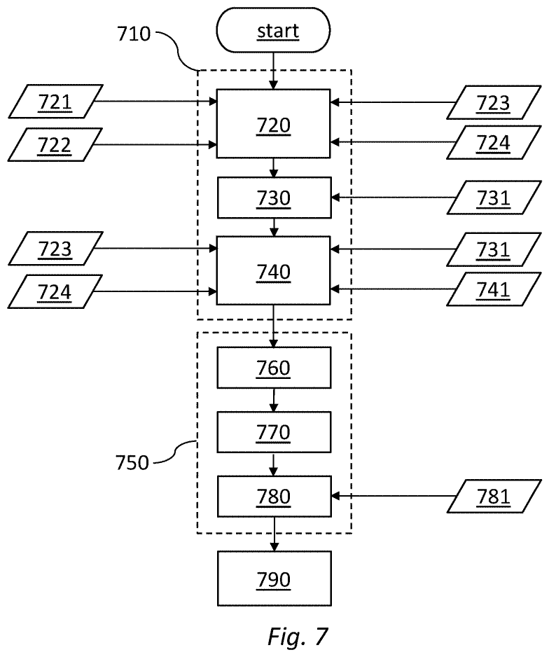

With reference to FIG. 7, a method of determining a payload of a work machine according to an embodiment of the present disclosure is illustrated. The work machine comprises a boom, a boom lift electronic actuator configured to actuate the boom and a tilt electronic actuator configured to actuate a coupler, wherein the coupler is configured to connect to a work tool. A difference between the centre of gravity of the payload and the centre of gravity used for a calibrated payload is compensated for. The method comprises determining a preliminary estimated weight value of the payload at steps 710. Step 720 comprises calculating a torque around a component configured to attach the boom to the work machine, such as a pin. Step 720 uses known kinematics and a net force on the boom lift electronic actuator 721, a net force on the tilt electronic actuator 722, a position of the boom 723 and a position of the tilt electronic actuator 724. The net force on the boom lift electronic actuator 721 is determined from a motor current of the boom lift electronic actuator, wherein the motor current is indicative of a motor torque and wherein the motor torque is indicative of a force on the actuator. The net force on the tilt electronic actuator 722 is determined from a motor current of the tilt electronic actuator, wherein the motor current is indicative of a motor torque and wherein the motor torque is indicative of a force on the actuator. At step 730, a weight lookup map or table is used to determine a friction compensation based on the velocity of the boom lift electronic actuator 731. At step 740, the preliminary estimated weight value is determined using the torque, friction compensation, a nominal linkage model and the position of the boom 723, the position of the tilt electronic actuator 724, the velocity of the boom lift electronic actuator 731 and a pitch of the work machine 741. The method further comprises adjusting the preliminary estimated weight value to provide an estimated payload weight value. The adjustment steps 750 comprise applying a calibration scale and offset at step 760 to provide a calibrated estimated weight value. At step 770 the calibrated estimated weight value is filtered to provide a filtered estimated weight value. The adjustment steps 750 further comprise adjusting the filtered estimated weight value for acceleration at step 780, using a filtered angular acceleration 781. At step 790, the method comprises outputting the estimated payload weight value. The adjustment steps 750 may be carried out in a different order.

In certain embodiments, the work machine may comprise a boom, a boom lift electronic actuator configured to actuate the boom, a tilt electronic actuator configured to actuate a coupler, wherein the coupler is configured to connect to a work tool, a stick connected to a distal end of the boom and a stick electronic actuator configured to actuate the stick. A coupler may be connected to a distal end of the stick, wherein the coupler may be configured to connect to a work tool. The methods described above may be used to determine the estimated payload weight value.

The step of determining a preliminary estimated weight value of the payload may use one or more of a position of the stick and a position of the coupler. In certain embodiments, determining a preliminary estimated weight value of the payload may use one or more of a velocity and an acceleration of one or more of the boom, the stick and the bucket.

Position, velocity and acceleration information may be provided by one or more of position feedback sensors, motor position and/or actuator position.

The positions of components mentioned herein may refer to the position of the component or to the position of the actuator configured to actuate that component. For example, a position of the boom may refer to any position of the boom, including one or more of the position of the boom itself, the position of the boom actuator and the position of a linkage element of the boom. The position may be determined by an encoder of actuator, wherein the encoder provides actuator length or extension and velocity feedback to a controller. Based on actuator length and known kinematics of the linkage, the linkage position and angular velocity can be determined. The position feedback sensors may be mounted on a linkage or elsewhere on a component and may comprise one or more of position sensing cylinders, inertial measurement units and rotational linkage sensors. The forces calculated in the preceding methods may comprise a force on an actuator or a force on a linkage element. For example, in certain embodiments the preliminary estimated weight value may be determined using a force on an actuator and a position of a linkage element. In other embodiments, the preliminary estimated weight value may be determined using a force on one or more linkage elements and one or more of a position, velocity and acceleration of the linkage elements.

Once an estimated payload weight value has been determined, the estimated payload weight value may be recorded against a corresponding loading event. The recorded payload weight may be added to a payload total. The payload total may be for the work machine. The payload total may be for the lifetime of a work machine, for a shift of the work machine, for a job of the work machine wherein the job comprises multiple shifts, or for any time period over which the work machine is used continuously or for discrete periods. For example, the payload total may be for a day, a week, a month or a year. The payload total may be for a plurality of work machines or for a work site.

The estimated payload weight value may be compared to a threshold weight value. For example, the estimated payload weight value may be used to check whether a work machine is carrying a payload that is within a certain tolerance. The estimated payload weight value may be used to determine productivity or efficiency of a work machine.

The methods described above may be carried out continuously or at intervals.

The methods described above may further comprise an initial step of checking whether a payload determining feature is installed on the work machine, and whether the payload determining feature is calibrated.

In the forgoing, electric actuators may comprise any electric or electromechanical actuator, including cylinder actuators and any linear actuator. The work tool may comprise any work tool configured to carry, lift or manoeuvre a payload. For example, the work tool may comprise a bucket or a fork.

According to an embodiment of the present disclosure, a device is configured to determine a payload weight of a work machine, wherein the work machine comprises a boom and a boom lift electronic actuator configured to actuate the boom. The device is configured to carry out any of the methods described herein. The device may comprise a controller configured to carry out the method.

The device is configured to determine a preliminary estimated weight value of the payload using a net force on the boom lift electronic actuator and a position of the boom. The net force is determined from a motor current of the boom lift electronic actuator, wherein the motor current is indicative of a motor torque and wherein the motor torque is indicative of a force on the actuator. The device is further configured to adjust the preliminary estimated weight value to provide an estimated payload weight value, wherein the adjustment comprises filtering. The device is further configured to output the estimated payload weight value.

1. A method of determining an estimated payload weight of a work machine, wherein the work machine comprises a boom and a boom lift electronic actuator configured to actuate the boom, the method comprising:
determining a preliminary estimated weight value of the payload using:
a net force on the boom lift electronic actuator determined from a motor current of the boom lift electronic actuator, wherein the motor current is indicative of a motor torque and wherein the motor torque is indicative of a net force on the actuator; and
a position of the boom;
adjusting the preliminary estimated weight value to provide an estimated payload weight value, wherein the adjustment comprises filtering; and
outputting the estimated payload weight value.

2. The method of claim 1 wherein the adjustment further comprises compensating for acceleration by using a filtered angular acceleration.

3. The method of claim 1 wherein the step of determining the preliminary estimated weight value comprises using a weight lookup table.

4. The method of claim 3 wherein the weight lookup table comprises friction compensation based on a velocity of the boom lift electronic actuator.

5. The method of claim 1 wherein the work machine further comprises:
a coupler configured to connect to a work tool; and
a tilt electronic actuator configured to actuate the coupler.

6. The method of claim 5 wherein the method further comprises using the tilt electronic actuator position to adjust the preliminary estimated weight value to compensate for tilt angle.

7. The method of claim 5 wherein the step of determining a preliminary estimated weight value of the payload comprises:
determining a supporting torque around a pin based on:
a net force on the boom lift electronic actuator determined from a motor current of the boom lift electronic actuator, wherein the motor current is indicative of a motor torque and wherein the motor torque is indicative of a net force on the actuator;
a net force on the tilt cylinder determined from a motor current of the tilt electronic actuator, wherein the motor current is indicative of a motor torque and wherein the motor torque is indicative of a net force on the actuator;
a position of the boom; and
a position of the tilt electronic actuator; and
determining the preliminary estimated weight value based on the supporting torque and the position of the boom.

8. The method of claim 7 wherein determining the preliminary estimated weight value based on the supporting torque and the position of the boom further comprises using a machine pitch and the position of the tilt electronic actuator, and wherein the preliminary estimated weight value is determined based on the supporting torque, the position of the boom, the machine pitch and the position of the tilt electronic actuator using a nominal linkage model.

9. The method of claim 5 wherein the work machine further comprises:
a stick connected to a distal end of the boom;
a stick electronic actuator configured to actuate the stick;
wherein the coupler is connected to a distal end of the stick.

10. The method of claim 9 wherein determining a preliminary estimated weight value of the payload further uses one or more of:
a position of the stick; and
a position of the coupler.

11. The method of claim 9 wherein determining a preliminary estimated weight value of the payload further uses one or more of a velocity and an acceleration of one or more of the boom, the stick and the bucket.

12. The method of claim 1 further comprising recording the estimated payload weight value against a corresponding loading event.

13. The method of claim 12 wherein the payload value is added to a payload total for one or more of:
the work machine;
a time period of use of the work machine; and
a time period of work at a work site.

14. The method of claim 1 wherein the method further comprises comparing the estimated payload weight value to a threshold weight value.

15. A device configured to determine an estimated payload weight value of a work machine, wherein the work machine comprises a boom and a boom lift electronic actuator configured to actuate the boom, and wherein the device is configured to:
determine a preliminary estimated weight value of the payload using:
a net force on the boom lift electronic actuator determined from a motor current of the boom lift electronic actuator, wherein the motor current is indicative of a motor torque and wherein the motor torque is indicative of a net force on the actuator; and
a position of the boom;
adjust the preliminary estimated weight value to provide an estimated payload weight value, wherein the adjustment comprises filtering; and
output the estimated payload weight value.
